(19) United States
(12) Patent Application Publication
(10) Pub. No.: US 2025/0095947 A1
(43) Pub. Date: Mar. 20, 2025

(54) ROTARY PISTON X-RAY SOURCE WITH AN ASYMMETRIC DEFLECTION UNIT

(71) Applicant: Siemens Healthineers AG, Forchheim (DE)

(72) Inventors: Florian HOLCH, Nuernberg (DE); Michael WIESSNER, Wiesentheid (DE); Florian SEPERANT, Nuernberg (DE); Dieter MATUSZOK, Weisendorf (DE); Peter ROEHRER, Erlangen (DE)

(73) Assignee: Siemens Healthineers AG, Forchheim (DE)

(21) Appl. No.: 18/888,545

(22) Filed: Sep. 18, 2024

(30) Foreign Application Priority Data
Sep. 20, 2023 (DE) 10 2023 209 165.8

(51) Int. Cl. H01J 35/30; H01J 35/14

(52) U.S. Cl. CPC H01J 35/305; H01J 35/14

(57) ABSTRACT

A rotary piston X-ray source including a housing, a rotary piston X-ray source, and a magnetic deflection unit. The rotary piston X-ray source is mounted inside the housing to be rotatable about an axis of rotation relative to the housing. The magnetic deflection unit includes at least one multipole and is disposed outside the rotary piston. The at least one multipole has at least four magnetic poles, which are disposed about the axis of rotation and include coil windings. The magnetic poles further define a multipole plane on which a central axis of the at least one multipole is perpendicularly centered, and the at least one multipole is arranged such that the central axis of the at least one multipole and the axis of rotation span a surface.

### CROSS-REFERENCE TO RELATED APPLICATION(S)

The present application claims priority under 35 U.S.C. § 119 to German Patent Application No. 10 2023 209 165.8, filed Sep. 20, 2023, the entire contents of which is incorporated herein by reference.

### FIELD

One or more embodiments of the present invention relate to a rotary piston X-ray source.

### BACKGROUND

The main difference between a rotary piston X-ray source and a rotating anode X-ray source is that, in a rotary piston X-ray source, the anode in the rotary piston X-ray source co-rotates with the evacuated rotary piston of the rotary piston X-ray source. In contrast, in a rotating anode X-ray source, the anode rotates within the evacuated X-ray source, with the evacuated X-ray source remaining stationary.

This results in a further difference, namely in particular the positioning of an electron emitter relative to the anode. In both rotating anode and rotary piston X-ray sources, a focal track is typically provided in an off-center region of the anode.

In the rotary piston X-ray source, the electron emitter is therefore typically disposed on the axis of rotation and therefore centrally above the anode. The central positioning of the electron emitter in a rotating anode X-ray source also means that the electrons must be deflected relatively strongly toward the focal track on the anode via a deflection unit.

In the rotating anode X-ray source, on the other hand, the electron emitter is disposed off-center, preferably directly above the focal track on the anode, so that the electrons in a rotating anode X-ray source have to be deflected much less strongly toward the focal track than in a rotary piston X-ray source. Depending on the design of the rotating anode X-ray source, a deflection unit may optionally be provided for this purpose.

For a conventional rotary piston X-ray source, it is known that, despite an almost entirely homogeneous electron distribution at the electron emitter during the emission of electrons, a more inhomogeneous electron distribution can occur on the focal track. This more inhomogeneous electron distribution results in particular from the comparatively strong deflection via the deflection unit. For example, the deflection unit of a conventional rotary piston X-ray source can comprise two quadrupoles which cause a partial crossover of the electron trajectories due to their deflection, resulting in the more inhomogeneous electron distribution. Lastly, the more inhomogeneous electron distribution is disadvantageous due to the resulting increase in the thermal load on the focal track.

### SUMMARY

An object of embodiments of the present invention is to provide a rotary piston X-ray source with a more homogeneous electron distribution on the anode.

At least this object is achieved by the features of the independent claims. Advantageous embodiments are described in the dependent claims.

Irrespective of the grammatical gender of a particular term, it is inclusive of persons of any gender, male, female or otherwise.

The rotary piston X-ray source according to an embodiment of the present invention has:
a housing,
a rotary piston X-ray tube and
a magnetic deflection unit,
wherein the rotary piston X-ray tube is mounted inside the housing so as to be rotatable about an axis of rotation relative to the housing,
wherein the rotary piston X-ray tube has a cathode, an evacuated rotary piston and an anode,
wherein the anode is non-rotatably connected to the rotary piston,
wherein the cathode has an electron emitter for emitting electrons and is disposed inside the rotary piston on the axis of rotation,
wherein the magnetic deflection unit comprises at least one multipole and is disposed outside the rotary piston, wherein the at least one multipole has at least four magnetic poles which are disposed around the axis of rotation and comprise coil windings in each case,
wherein the magnetic poles further define a multipole plane, with a central axis of the at least one multipole centered perpendicularly thereto,
characterized in that
the at least one multipole is disposed such that the central axis of the at least one multipole and the axis of rotation span a surface.

One advantage of the rotary piston X-ray source according to embodiments of the present invention is that the electron distribution density can be increased. This higher power of the rotary piston X-ray source is made possible in particular by the fact that the electron distribution of the rotary piston X-ray source according to an embodiment of the present invention is more homogeneous. This is because a more homogeneous electron distribution has fewer power peaks due to inhomogeneities. The more homogeneous electron distribution is achieved in particular by an asymmetric magnetic deflection unit according to the inventive rotary piston X-ray source according. The asymmetry of the magnetic deflection unit is achieved in particular by an offsetting of the multipole, in particular of at least a portion of the coil windings, relative to the axis of rotation and/or by tilting the multipole relative to the axis of rotation. The rotary piston X-ray source according to an embodiment of the present invention advantageously allows larger anodes because of the stronger deflection produced by the magnetic deflection unit. Larger anodes typically have a higher heat capacity and can thus be more powerful and/or have a longer service life.

The rotary piston X-ray source is designed in particular for imaging. The imaging can in particular be medical imaging. Alternatively or in addition, the imaging can be an application of the rotary piston X-ray source for a security checkpoint, customs control and/or materials testing. In principle, it is conceivable for the rotary piston X-ray source to be designed for a therapeutic application using X-rays.

In contrast to a rotating anode X-ray source, the rotary piston X-ray source has a rotatable rotary piston X-ray tube. It is basically conceivable that, in addition to the anode, the electron emitter could also be mounted so as to co-rotate with the evacuated rotary piston. In this case, the electron emitter is non-rotatably connected to the rotary piston. Alternatively, the electron emitter can be non-rotatably connected to the housing and/or to a stationary part of the bearing of the rotary piston X-ray tube.

The housing of the rotary piston X-ray source typically contains a cooling medium and/or insulating medium outside the rotary piston X-ray source. The cooling medium can be designed as an insulating medium. The insulating medium is designed in particular for high-voltage insulation of the rotary piston X-ray source. The cooling medium and/or insulating medium can in particular be liquid or gaseous. The housing of the rotary piston X-ray source is advantageously fluid-tight and can be closed and/or sealable.

The evacuated rotary piston of the rotary piston X-ray source generally forms a vacuum enclosure which typically encloses a high vacuum. The electrons that can be generated via the electron emitter move from the cathode toward the anode in particular along an electromagnetic field within the high vacuum. The vacuum enclosure typically comprises metal and/or glass. The evacuated rotary piston is in particular cylindrical or conical or frustoconical or biconical. It is conceivable for the evacuated rotary piston to be composed of a plurality of enclosure sections having different conical or cylindrical shapes. The evacuated rotary piston is in particular rotationally symmetrical.

The electron emitter can in particular be a thermionic or field-effect emitter. It is basically conceivable for the electron emitter to comprise a plurality of emitter elements. The plurality of emitter elements can be thermionic or field-effect emitters. Alternatively, it is conceivable that the electron emitter comprises a thermionic emitter and field-effect emitter combination.

The electrons of the electron emitter are emitted in particular along the axis of rotation centrally above the anode on the axis of rotation. An electron trajectory thus typically begins centrally above the anode and/or on the axis of rotation.

The anode typically comprises tungsten, molybdenum and/or rhenium. An anode surface can have regular structures. The anode is specifically a disk anode. The co-rotation of the rotary piston with the anode during operation of the rotary piston X-ray source enables a focal spot, where the electrons generate the X-rays, to form on the anode in a ring shape, creating a focal track. In the focal spot region, the incoming electrons in particular interact with the anode, wherein the kinetic energy of the electrons is largely converted into heat. The focal track is preferably disposed in a peripheral region of the anode in order to increase the length of the focal track by virtue of its larger diameter, thereby increasing the heat dissipation of the focal track. Advantageously, the larger the diameter of the focal track, and hence the longer the focal track, the more powerful the rotary piston X-ray source because of the thereby increased heat dissipation, i.e. the more electrons are incident on the anode.

The electromagnetic field for accelerating the electrons is typically an acceleration field which can in particular comprise electric and/or magnetic field components and can move, or more specifically deflect, the electrons from the electron emitter on the axis of rotation toward the focal track in an off-center region of the anode. The magnetic field components and the electric field components in particular overlap and/or generally create the acceleration field. Because of this overlapping and the physical interaction with the electrons, the electron accelerating, deflecting and focusing functions in particular are strongly interdependent. Approximately, the electric field components can influence the electrons in a direction along the axis of rotation, while the magnetic field components influence the electrons in particular in a direction perpendicular to the axis of rotation. Influencing the electrons means in particular that a force can be exerted on the electrons by the field components, resulting in particular in an acceleration and/or a change in direction.

The electric field components can be generated by an acceleration unit, for example. The acceleration unit can comprise a high-voltage source that can preferably apply a voltage of between 40 and 150 kV between the cathode and the anode. In the case of a unipolar rotary piston X-ray source, the voltage difference can be distributed in particular across ground potential at the anode and high-voltage potential of up to −150 kV at the cathode. Alternatively, in the case of a bipolar rotary piston X-ray source, the high-voltage potential of the anode can be 75 kV and the high-voltage potential of the cathode −75 kV.

The magnetic field components of the acceleration field can be generated in particular by the magnetic deflection unit. The magnetic field components of the magnetic deflection unit can in particular change the direction of the individual electrons. Ideally, the magnetic field components are set by the magnetic deflection unit such that an electron beam formed by the electrons can be deflected and/or focused. Deflecting the electron beam includes, in particular, diverting the majority of the electrons from the axis of rotation toward the focal path. Focusing the electron beam includes, in particular, changing, in particular reducing and/or enlarging, the electron beam cross-section.

The magnetic deflection unit is typically non-rotatably connected to the housing. In this case, during operation of the rotary piston X-ray tube, the rotary piston X-ray tube, in particular the anode, rotates relative to the magnetic deflection unit. In particular, the magnetic deflection unit is designed to be stationary.

The evacuated rotary piston can in particular have a cylindrical housing section along the axis of rotation, wherein the cylindrical housing section has a smaller diameter than that of the anode. Advantageously, the magnetic deflection unit encompasses the cylindrical housing section having the smaller diameter.

The at least one multipole can have a circumferential yoke. The circumferential yoke can lie in one plane, in particular be a planar yoke. Alternative non-planar variants are described in the embodiments. The yoke and the pole are typically made of the same material and/or are integrally formed. A pole can basically correspond to a yoke section or be formed as a projection on the circumferential yoke. Basically, all the poles can be formed as a projection on the circumferential yoke. A pole is characterized in particular by the coil winding surrounding it. The fact that the poles each comprise coil windings means in particular that a coil winding is disposed around each pole.

The fact that the four magnetic poles are disposed around the axis of rotation means in particular that the four magnetic poles surround the electrons. Advantageously, the at least four poles are disposed in a multipole plane in such a way that a surface bounded by the at least four poles is intersected by the axis of rotation. The magnetic deflection unit, in particular the four magnetic poles, is generally disposed between the cathode and the anode. The four magnetic poles are preferably disposed in a regularly and/or symmetrically and/or equidistantly distributed manner.

Each multipole typically has a multipole plane. A multipole plane depends on the positioning of the poles relative to one another. Depending on the design of the magnetic poles, a central point of the pole and/or an end point of the pole and/or a central point of the respective winding package of the pole can define the position of the pole. The position of the pole can in particular depend on the respective coil winding and/or on the respective yoke or yoke section. The position of the pole can in particular depend on a material, a curvature, a diameter and/or a length of the coil winding and/or of the yoke or yoke section.

The four magnetic poles can typically be assigned pairwise to a straight line in each case, wherein the two straight lines lie in the multipole plane. The two straight lines can in particular be aligned parallel or have a common point of intersection. In this case, the four magnetic poles, i.e. all the poles, of the at least one multipole define, in particular geometrically, the multipole plane and/or lie in the multipole plane.

An embodiment is basically conceivable in which a portion of the magnetic poles lies in a first plane and another portion of the magnetic poles lies in a second plane, wherein an intersection of the portion and the other portion can be non-zero. In a specific example, three magnetic poles can lie in the first plane and two of the three magnetic poles and a further magnetic pole can lie in a second plane, wherein the first plane and the second plane are not congruent and/or enclose an angle. In this case, the multipole plane is determined such that the first plane is shifted away from the two of the three magnetic poles toward the further magnetic pole. The same result is usually obtained if the second plane is shifted away from the two of the three magnetic poles toward the third of the three magnetic poles. In this case, geometrically, only those poles of the multipole that do not lie in the intersection of the portion ultimately define the multipole plane, wherein in particular the poles of the intersection can form a straight line lying parallel to the multipole plane.

Each multipole plane has in particular a central axis. The central axis of the at least one multipole can be equidistant from all the poles of the multipole. It is possible for the magnetic poles to be disposed such that only pairs of magnetic poles are equidistant from the central axis. The central axis intersects the multipole plane, in particular at its central point, which is generally predefined by the magnetic poles. The central point specifically forms the geometric center of the multipole plane, with the central axis positioned at the central point, i.e. at the center of the multipole plane.

The fact that the central axis of the at least one multipole and the axis of rotation span a surface means in particular that the magnetic poles of the at least one multipole are disposed accordingly relative to the axis of rotation. The at least one multipole is in particular disposed asymmetrically relative to the axis of rotation, e.g. it is shifted and/or tilted.

Spanning a surface means in particular that the central axis of the at least one multipole and the axis of rotation are not congruent and/or do not lie on the same straight line. In this case, the surface area is greater than zero. Typically no surface is spanned if the central axis of the at least one multipole and the axis of rotation are congruent or lie on the same straight line. In this case, the surface area is zero.

From a geometric point of view, spanning a surface also typically requires that the central axis intersects the axis of rotation at a common point of intersection, forming an angle, or that the central axis and the axis of rotation are aligned parallel to each other. The first case is described in the following embodiments and is essentially equivalent to the axis of rotation on the multipole plane being at an angle other than 90°, in particular not perpendicular. The latter case, i.e. parallel alignment, is described in further embodiments after the following embodiments and is essentially equivalent to the axis of rotation being disposed parallel to the central axis.

A combination of these two cases, i.e. a non-zero angle and thus a non-parallel offset, is basically conceivable. In the case of a combination, it is particularly the case that the central point at which the central axis intersects the multipole plane and the axis of rotation span a surface. In this case, the offset refers to a non-zero distance between the central point and the axis of rotation.

The following section describes in particular embodiments which can be roughly divided into asymmetric arrangements with a symmetrical multipole or arrangements with an asymmetric multipole. In particular, virtually any combination of these embodiments is possible.

One embodiment provides that the central axis of the at least one multipole and the axis of rotation are at a non-zero angle to one another. In particular, the central axis intersects the axis of rotation at a common point of intersection. Advantageously, the common point of intersection of the central axis and the axis of rotation is the central point of the multipole plane. The angle between the central axis and the axis of rotation is advantageously at least 1°, preferably more than 5°. With respect to another angle between the multipole plane and the axis of rotation, the other angle is thus less than or equal to 89°, preferably less than or equal to 85°.

One embodiment provides that the at least one multipole has a circumferential yoke, wherein the circumferential yoke has a bend in the direction of the axis of rotation such that one segment of the yoke has a different angle relative to the axis of rotation than the other segment of the yoke. The circumferential yoke preferably completely surrounds the axis of rotation. The circumferential yoke is in particular a self-contained yoke which can have straight and/or curved yoke sections. The bend in the direction of the axis of rotation is in particular visible in a side view along the axis of rotation. The segment of the yoke and the other segment of the yoke define in particular two different, non-congruent planes which have different angles with respect to the axis of rotation.

One embodiment provides that the at least one multipole has a planar circumferential yoke, wherein at least one pole of the at least one multipole has a different angle relative to the plane of the circumferential yoke compared to another pole of the at least one multipole. In this case, the pole with the different angle is in particular designed as a projection on the circumferential yoke.

One embodiment provides that the central point of the multipole plane of the at least one multipole and the axis of rotation are at a non-zero distance. Preferably, the distance is at least 1 mm, preferably more than 5 mm.

If the central axis of the at least one multipole and the axis of rotation are at a zero angle to each other and this embodiment therefore describes an offset as an alternative to the previous embodiments with a non-zero angle, this embodiment is equivalent to the central axis of the multipole plane of the at least one multipole being aligned parallel to the axis of rotation. In this case, the central axis of the multipole plane of the at least one multipole is at a non-zero distance from the axis of rotation.

If the central axis of the at least one multipole and the axis of rotation are at a non-zero angle to each other and thus a combination of the non-zero angle and the offset is involved, this embodiment is equivalent to the central axis of the multipole plane of the at least one multipole not being aligned parallel to the axis of rotation.

All the preceding embodiments can be differentiated in particular in terms of whether the central axis of the at least one multipole intersects the anode in a region between the axis of rotation and the focal spot or whether the central axis of the at least one multipole intersects the anode outside a region between the axis of rotation and the focal spot. In the former case, the at least one multipole is disposed closer to the focal point in many embodiments than in the latter case. Depending on the design of the at least one multipole, both variants can be useful.

One embodiment provides that the magnetic deflection unit has a further multipole. The magnetic deflection unit thus has the further multipole in addition to the at least one multipole. This embodiment is particularly advantageous because, for example, the further multipole can be designed to deflect the electrons and the at least one multipole to focus the electrons. In principle, the further multipole has a multipole plane that can be defined in the same way as the multipole plane of the at least one multipole as described above.

It is conceivable for the at least one multipole to be of identical design to the further multipole. In particular, the at least one multipole and the further multipole can have the same number of magnetic poles and/or the same arrangement of the magnetic poles relative to one another. In this case, the at least one multipole can differ from the further multipole in particular only in its positioning along the axis of rotation, but not in its orientation with respect to the axis of rotation. As an alternative to the identical design, it is conceivable for only one of the multipoles to have a bent circumferential yoke and/or a bent pole. In particular, it is possible for the further multipole to have fewer, e.g. two, or more, e.g. six, magnetic poles than the at least one multipole.

One embodiment provides that the at least one multipole and the further multipole differ in their orientation relative to the axis of rotation. The orientation relates in particular to an angle between the respective central axis and the axis of rotation, as well as to a distance between the respective central point of the multipole plane and the axis of rotation. In this exemplary embodiment, the angle and/or the distance of the at least one multipole and of the further multipole therefore differ. This embodiment expressly also includes variants in which an angle of a multipole and/or a distance of a multipole is zero.

One embodiment provides that the central point of the multipole plane of the further multipole and the axis of rotation are at a non-zero distance. In this regard, the previous statements regarding the corresponding embodiment of the at least one multipole also apply unchanged to the further multipole.

One embodiment provides that the further multipole is designed such that the central axis of the further multipole and the axis of rotation are at a non-zero angle. In this regard, the previous statements regarding the corresponding embodiment of the at least one multipole also apply unchanged to the further multipole.

An alternative embodiment to the previous two embodiments provides that the further multipole is designed such that the central axis of the further multipole and the axis of rotation have a zero angle and a zero distance with respect to one another. In this case, the central axis of the further multipole lies on the axis of rotation.

### BRIEF DESCRIPTION OF THE DRAWINGS

The present invention will now be described and explained in more detail with reference to the exemplary embodiments shown in the figures. In the following description of the figures, structures and units essentially remaining the same will be designated by the same reference character as when the respective structure or unit first appears.

FIG. 1 shows a conventional rotary piston X-ray source,

FIG. 2 shows a first exemplary embodiment of a rotary piston X-ray source according to the present invention,

FIG. 3 shows a second exemplary embodiment of a rotary piston X-ray source according to the present invention,

FIG. 4 shows a third exemplary embodiment of a rotary piston X-ray source according to the present invention,

FIG. 5 shows a fourth exemplary embodiment of a rotary piston X-ray source according to the present invention,

FIG. 6 shows an electron distribution of the rotary piston X-ray source according to the present invention,

FIG. 7 shows a fifth exemplary embodiment of a rotary piston X-ray source according to the present invention,

FIG. 8 shows a sixth exemplary embodiment of a rotary piston X-ray source according to the present invention,

FIG. 9 shows a seventh exemplary embodiment of a rotary piston X-ray source according to the present invention, and

FIG. 10 shows an eighth exemplary embodiment of a rotary piston X-ray source according to the present invention.

### DETAILED DESCRIPTION

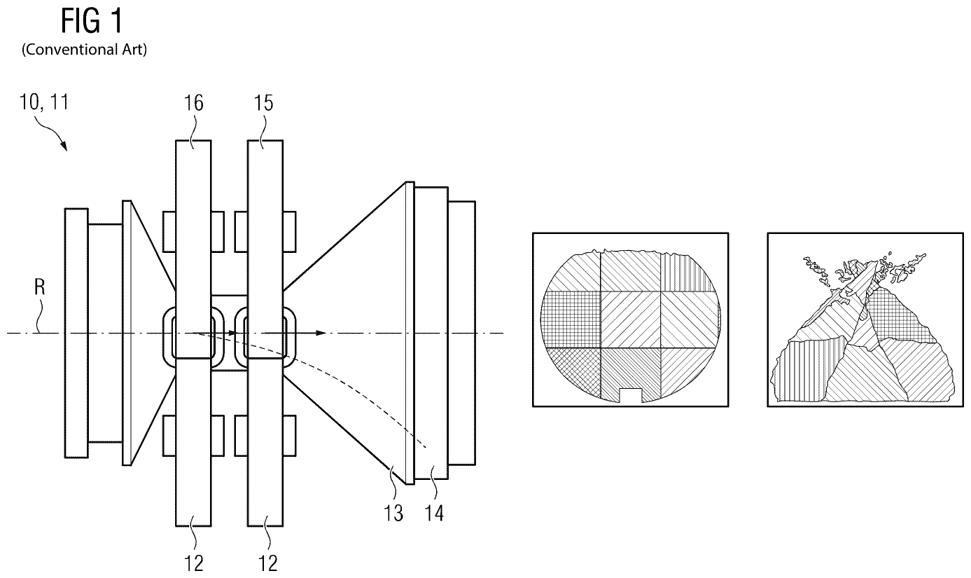

FIG. 1 shows a side view of a conventional rotary piston X-ray source 10.

The conventional rotary piston X-ray source 10 has a housing (not shown), a rotary piston X-ray tube 11 and a magnetic deflection unit 12.

The rotary X-ray tube 11 is mounted inside the housing so as to be rotatable about an axis of rotation R relative to the housing. The rotary X-ray tube 11 has a cathode (not shown), an evacuated rotary piston 13 and an anode 14. The anode 14 is non-rotatably connected to the rotary piston 13. The cathode has an electron emitter for emitting electrons and is disposed inside the rotary piston on the axis of rotation R.

The trajectories of the centrally emitted electrons are illustrated by way of example using the dotted line and show the comparatively strong deflection in the direction of an off-center region of the anode 14 in which the focal spot is located. Next to the side view of the conventional rotary piston X-ray source 10, FIG. 1 shows an electron distribution close to the electron emitter and therefore more toward the start of the dashed line. On the far right of FIG. 1, an electron distribution close to the focal spot and therefore more toward the end of the dashed line is shown.

The magnetic deflection unit 12 comprises at least one multipole 15 and one further multipole 16. The magnetic deflection unit 12 is disposed outside the rotary piston 13. The at least one multipole 15 and the further multipole 16 each have four magnetic poles on a circumferential yoke, each forming a quadrupole. The magnetic poles are disposed around the axis of rotation R, each comprising coil windings and encircling the emitted electrons.

The four magnetic poles of the at least one multipole 15 define a multipole plane on which a central axis of the at least one multipole 15 is perpendicularly centered. The four magnetic poles of the further multipole 16 define a further multipole plane on which a central axis of the further multipole 16 is perpendicularly centered.

The arrows indicate the central axis of the at least one multipole 15 and of the further multipole 16 and are congruent with the axis of rotation R. The at least one multipole 15 is thus designed such that the central axis of the at least one multipole 15 and the axis of rotation R do not span a surface. In other words, the central axis of the at least one multipole 15 and the axis of rotation R have a zero degree angle and zero distance between them. The same applies to the further multipole 16.

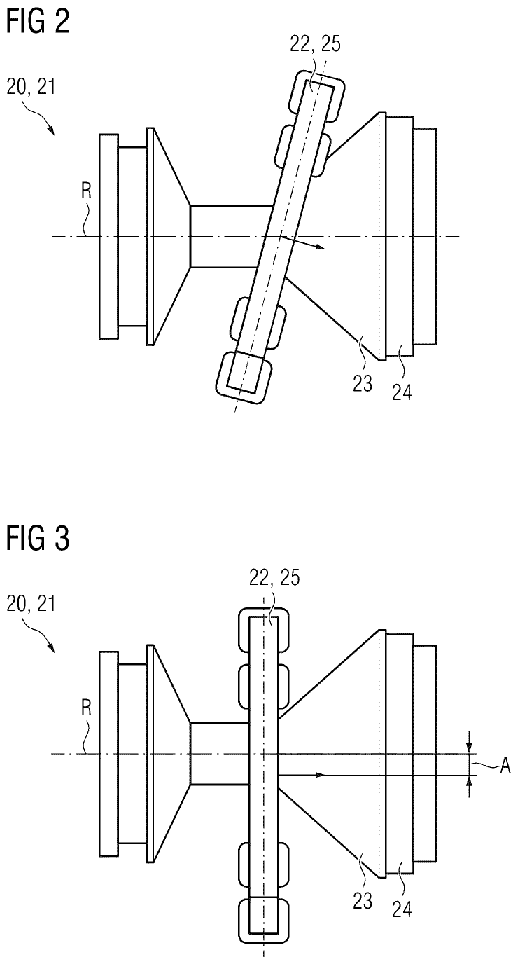

FIG. 2 shows a side view of a first exemplary embodiment of a rotary piston X-ray source 20 according to the present invention.

The rotary piston X-ray source 20 comprises a housing (not shown), a rotary piston X-ray tube 21 and a magnetic deflection unit 22.

The rotary piston X-ray tube 21 is mounted inside the housing so as to be rotatable about an axis of rotation R relative to the housing. The rotary piston X-ray tube 21 has a cathode (not shown), an evacuated rotary piston 23 and an anode 24. The anode 24 is non-rotationally connected to the rotary piston 23. The cathode has an electron emitter for emitting electrons and is disposed on the axis of rotation R inside the rotary piston.

The magnetic deflection unit 22 comprises at least one multipole 25. The magnetic deflection unit 22 is disposed outside the rotary piston 23. The at least one multipole 25 has four magnetic poles on a circumferential yoke, thus forming a quadrupole. The magnetic poles are disposed about the axis of rotation R, each comprising coil windings and encircling the emitted electrons.

The four magnetic poles of the at least one multipole 25 define a multipole plane on which a central axis of the at least one multipole 25 is perpendicularly centered. The multipole plane, on which the central axis of the at least one multipole 25 is perpendicular centered, is represented by a dash-dotted line. The arrow indicates the central axis of the at least one multipole 25 and is not congruent with the axis of rotation R. The at least one multipole 25 is therefore designed such that the central axis of the at least one multipole 25 and the axis of rotation R span a surface. In this exemplary embodiment, the central axis of the at least one multipole 25 and the axis of rotation R form a non-zero angle.

In this embodiment, the angle is at least 1°, preferably more than 5°. Also in this embodiment, the central axis of the at least one multipole 25 intersects the anode 24 in a region between the axis of rotation R and the focal spot. In this embodiment, the focal spot is provided in the lower half of the anode 24. Alternatively, it is conceivable for the central axis of the at least one multipole 25 to intersect the anode 24 outside a region between the axis of rotation R and the focal spot.

FIG. 3 shows a side view of a second exemplary embodiment of a rotary piston X-ray source 20 according to the present invention.

The multipole plane on which the central axis of the at least one multipole 25 is perpendicularly centered is represented by a dash-dotted line. The at least one multipole 25 is arranged such that the central axis of the at least one multipole 25 and the axis of rotation R span a surface. The central point of the multipole plane of the at least one multipole 25 and the axis of rotation R are at a non-zero distance A. In this example, the central axis of the at least one multipole 25 and the axis of rotation R are aligned parallel to one another and are at a non-zero distance A apart. The distance A is preferably at least 1 mm, preferably more than 5 mm. In addition, in this embodiment, the central axis of the at least one multipole 22 intersects the anode 24 in a region between the axis of rotation R and the focal spot.

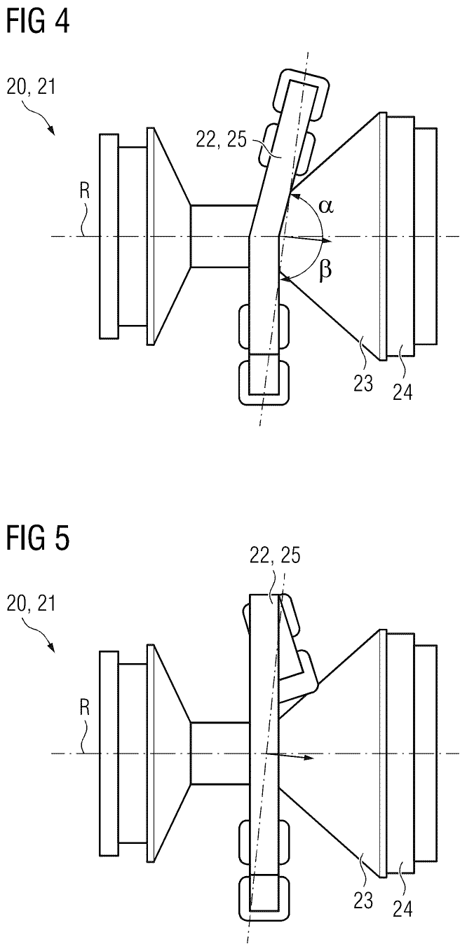

FIG. 4 shows a side view of a third exemplary embodiment of a rotary piston X-ray source 20 according to the present invention.

The multipole plane, on which the central axis of the at least one multipole 25 is perpendicularly centered, is represented by a dash-dotted line. The at least one multipole 25 is arranged such that the central axis of the at least one multipole 25 and the axis of rotation R span a surface. In this exemplary embodiment, the central axis of the at least one multipole 25 and the axis of rotation R form a non-zero angle. The circumferential yoke of the at least one multipole 25 has a bend in the direction of the axis of rotation R such that one segment of the yoke has a different angle relative to the axis of rotation R than the other segment of the yoke. The axis of rotation R divides the at least one multipole 25 into said segment and the other segment. The angles of the two segments are labeled a and B in FIG. 4.

FIG. 5 shows a side view of a fourth exemplary embodiment of a rotary piston X-ray source 20 according to the present invention.

The multipole plane, on which the central axis of the at least one multipole 25 is perpendicularly centered, is represented by a dash-dotted line. The at least one multipole 25 is arranged such that the central axis of the at least one multipole 25 and the axis of rotation R span a surface. In this exemplary embodiment, the central axis of the at least one multipole 25 and the axis of rotation R form a non-zero angle. The at least one multipole 25 has a planar circumferential yoke. At least one pole of the at least one multipole 25, in this exemplary embodiment there are two poles, has a different angle relative to the plane of the circumferential yoke compared to another pole of the at least one multipole 25.

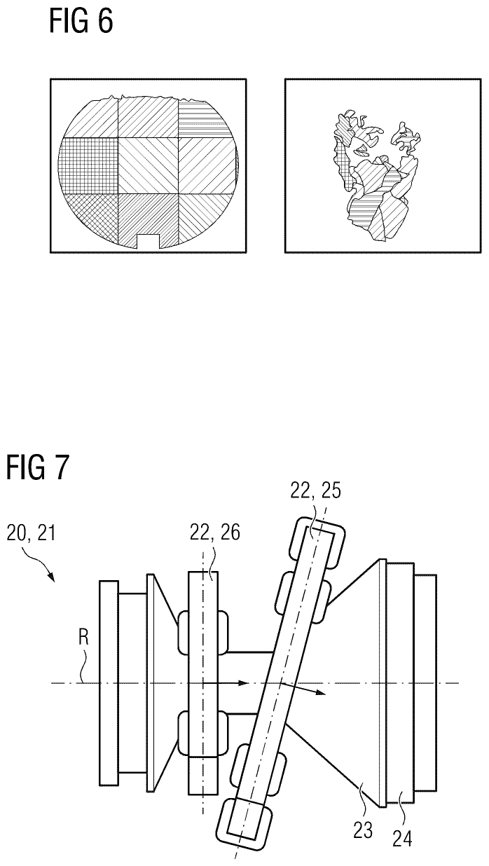

FIG. 6 shows an electron distribution of the rotary piston X-ray source 20 according to an embodiment of the present invention.

On the left, an electron distribution close to the electron emitter and therefore more toward the start of the electron trajectories is shown. On the right, an electron distribution close to the focal spot and therefore more toward the end of the electron trajectories is shown. This latter electron distribution is more homogeneous compared to the electron distribution of the conventional rotary piston X-ray source 10 shown far right in FIG. 1.

FIG. 7 shows a side view of a fifth exemplary embodiment of a rotary piston X-ray source 20 according to the present invention.

The fifth exemplary embodiment is a further development of the first exemplary embodiment shown in FIG. 2. Such a further development is also explicitly compatible with the second exemplary embodiment shown in FIG. 3 and/or the third exemplary embodiment shown in FIG. 4 and/or the fourth exemplary embodiment shown in FIG. 5.

The magnetic deflection unit 22 also has a further multipole 26. The at least one multipole 25 and the further multipole 26 differ in respect of their orientation relative to the axis of rotation R. The further multipole 26 is arranged such that the central point of the multipole plane of the further multipole 26 and the axis of rotation R are at a zero distance. The central axis of the further multipole 26 and the axis of rotation R do not span a surface. The at least one multipole 25 and the further multipole 26 have the same number of magnetic poles.

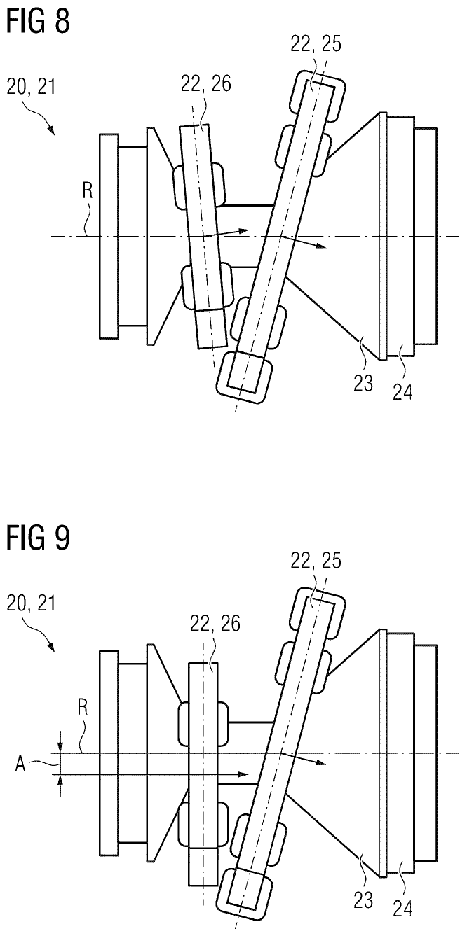

FIG. 8 shows a side view of a sixth exemplary embodiment of a rotary piston X-ray source 20 according to the present invention.

The sixth exemplary embodiment is a further development of the first exemplary embodiment shown in FIG. 2. Such a further development is also explicitly compatible with the second exemplary embodiment shown in FIG. 3 and/or the third exemplary embodiment shown in FIG. 4 and/or the fourth exemplary embodiment shown in FIG. 5.

The magnetic deflection unit 22 also has a further multipole 26. The at least one multipole 25 and the further multipole 26 differ in respect of their orientation relative to the axis of rotation R. The further multipole 26 is designed such that the central axis of the further multipole 26 and the axis of rotation R are at a non-zero angle to one another. The central axis of the further multipole 26 and the axis of rotation R span a surface. The central axis of the at least one multipole 25 and the central axis of the further multipole 26 together with the axis of rotation R form an isosceles triangle.

FIG. 9 shows a side view of a seventh exemplary embodiment of a rotary piston X-ray source 20 according to the present invention.

The seventh exemplary embodiment is a further development of the first exemplary embodiment shown in FIG. 2. Such a further development is also explicitly compatible with the second exemplary embodiment shown in FIG. 3 and/or the third exemplary embodiment shown in FIG. 4 and/or the fourth exemplary embodiment shown in FIG. 5.

The magnetic deflection unit 22 also has a further multipole 26. The at least one multipole 25 and the further multipole 26 differ in their orientation relative to the axis of rotation R. The further multipole 26 is arranged such that the central point of the multipole plane of the further multipole 26 and the axis of rotation R are at a non-zero distance A from one another. The central axis of the further multipole 26 and the axis of rotation R span a surface.

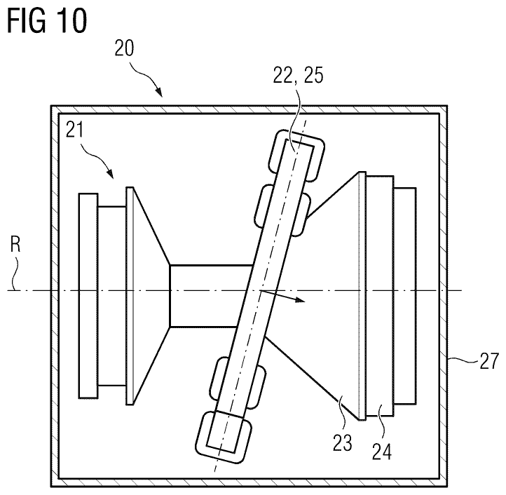

FIG. 10 shows a side view of an eighth exemplary embodiment of an X-ray source 20 according to the present invention with a cross-section through the housing 27 of the X-ray source 20.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing embodiments. The present invention may, however, be embodied in many alternate forms and should not be construed as limited to only the embodiments set forth herein.

Although the present invention has been illustrated and described in detail by the preferred exemplary embodiments, the present invention is not limited to the disclosed examples and other variations will be apparent to the person skilled in the art without departing from the scope of the present invention.

What is claimed is:

1. A rotary piston X-ray source, comprising:
a housing;
a rotary piston X-ray tube mounted inside the housing and configured to rotate about an axis of rotation and relative to the housing, the rotary piston X-ray tube having a cathode, an evacuated rotary piston and an anode, wherein
the anode is non-rotationally connected to the evacuated rotary piston,
the cathode includes an electron emitter configured to emit electrons, and
the cathode is disposed inside the evacuated rotary piston on the axis of rotation; and
a magnetic deflection unit including at least one multipole, wherein
the magnetic deflection unit is disposed outside the evacuated rotary piston,
the at least one multipole has at least four magnetic poles disposed about the axis of rotation and includes coil windings in each case,
the at least four magnetic poles define a multipole plane on which a central axis of the at least one multipole is perpendicularly centered, and
the at least one multipole is configured such that the central axis of the at least one multipole and the axis of rotation span a surface.

2. The rotary piston X-ray source as claimed in claim 1, wherein the central axis of the at least one multipole and the axis of rotation form a non-zero angle.

3. The rotary piston X-ray source as claimed in claim 2, wherein the non-zero angle is at least 5°.

4. The rotary piston X-ray source as claimed in claim 2, wherein
the at least one multipole has a circumferential yoke, and
the circumferential yoke has a bend in a direction of the axis of rotation such that a segment of the circumferential yoke has a different angle relative to the axis of rotation than another segment of the circumferential yoke.

5. The rotary piston X-ray source as claimed in claim 2, wherein
the at least one multipole has a planar circumferential yoke, and
at least one pole of the at least one multipole has a different angle relative to a plane of the planar circumferential yoke compared to another pole of the at least one multipole.

6. The rotary piston X-ray source as claimed in claim 1, wherein a central point of the multipole plane of the at least one multipole and the axis of rotation are at a non-zero distance.

7. The rotary piston X-ray source as claimed in claim 6, wherein the non-zero distance is at least 5 mm.

8. The rotary piston X-ray source as claimed in claim 1, wherein the central axis of the at least one multipole intersects the anode in a region between the axis of rotation and a focal spot.

9. The rotary piston X-ray source as claimed in claim 1, wherein the central axis of the at least one multipole intersects the anode outside a region between the axis of rotation and a focal spot.

10. The rotary piston X-ray source as claimed in claim 1, wherein the magnetic deflection unit comprises a further multipole.

11. The rotary piston X-ray source as claimed in claim 10, wherein the at least one multipole and the further multipole differ in orientation relative to the axis of rotation.

12. The rotary piston X-ray source as claimed in claim 10, wherein the at least one multipole and the further multipole have a same number of magnetic poles.

13. The rotary piston X-ray source as claimed in claim 10, wherein a central point of a multipole plane of the further multipole and the axis of rotation are at a non-zero distance.

14. The rotary piston X-ray source as claimed in claim 10, wherein the further multipole is arranged such that a central axis of the further multipole and the axis of rotation are at a non-zero angle with respect to each other.

15. The rotary piston X-ray source as claimed in claim 10, wherein the further multipole is arranged such that a central axis of the further multipole and the axis of rotation are at a zero angle and a zero distance with respect to each other.

16. The rotary piston X-ray source as claimed in claim 2, wherein the non-zero angle is at least 1°.

17. The rotary piston X-ray source as claimed in claim 6, wherein the non-zero distance is at least 1 mm.

18. The rotary piston X-ray source as claimed in claim 4, wherein
the at least one multipole has a planar circumferential yoke, and
at least one pole of the at least one multipole has a different angle relative to a plane of the circumferential yoke compared to another pole of the at least one multipole.

19. The rotary piston X-ray source as claimed in claim 11, wherein a central point of a multipole plane of the further multipole and the axis of rotation are at a non-zero distance.

20. The rotary piston X-ray source as claimed in claim 11, wherein the further multipole is arranged such that a central axis of the further multipole and the axis of rotation are at a non-zero angle with respect to each other.
